(19) United States
(12) Patent Application Publication
(10) Pub. No.: US 2020/0018715 A1
(43) Pub. Date: Jan. 16, 2020

(54) POTENTIOMETRIC SENSOR ASSEMBLY AND A METHOD FOR MONITORING THE SENSOR FUNCTION OF A POTENTIOMETRIC SENSOR

(71) Applicant: ABB Schweiz AG, Baden (CH)

(72) Inventors: Benjamin Carr, Gloucestershire (GB); Dave Albone, St. Neots (GB)

(21) Appl. No.: 16/503,716

(22) Filed: Jul. 5, 2019

(30) Foreign Application Priority Data
Jul. 10, 2018 (EP) 18182647.0

(51) Int. Cl. G01N 27/20

(52) U.S. Cl. CPC G01N 27/20

(57) ABSTRACT

A method for monitoring a sensor function of a potentiometric sensor that includes: an ion-sensitive electrode including an ion-sensitive glass bulb; a reference electrode assembly including a reference electrode; and an ion-sensing circuit having a first terminal connected to the ion-sensitive electrode and a second terminal connected to the reference electrode, the circuit measuring the potential difference that develops in the loop between the reference and the ion-sensitive electrode. The method includes the steps of: a) injecting a pre-defined electric test current from the ion-sensing circuit into the loop comprising the reference and the ion-sensitive electrode; b) monitoring an additional potential difference that develops in the loop between the reference and the ion-sensitive electrode in reaction to the injection of the test current; and c) determining if the additional potential difference is within an expected range characterizing healthy function of the sensor.

### CROSS-REFERENCE TO PRIOR APPLICATION

Priority is claimed to European Patent Application No. EP 18182647.0, filed on Jul. 10, 2018, the entire disclosure of which is hereby incorporated by reference herein.

### FIELD

The invention is about a potentiometric sensor assembly, comprising an ion-sensitive electrode including an ion-sensitive glass bulb, further comprising a reference electrode assembly including a reference electrode, further comprising an ion-sensing circuit having a first terminal connected to the ion-sensitive electrode and a second terminal connected to the reference electrode, the circuit being designed to measure the potential difference that develops in the loop between the reference and the ion-sensitive electrode, further comprising a digital storage unit which is designed to save at least a range of values of the electric impedance of the glass bulb characterizing a healthy function of the sensor.

### BACKGROUND

The invention is further about a method for monitoring the sensor function of a potentiometric sensor, the potentiometric sensor comprising an ion-sensitive electrode including an ion-sensitive glass bulb, further comprising a reference electrode assembly including a reference electrode, further comprising an ion-sensing circuit having a first terminal connected to the ion-sensitive electrode and a second terminal connected to the reference electrode, the circuit being designed to measure the potential difference that develops in the loop between the reference and the ion-sensitive electrode.

Such a potentiometric sensor assembly applies an ion-sensitive electrode to measure an ion concentration in a liquid sample. The sensitivity is determined by the ion-sensitive glass-bulb. The electronic equivalent to the ion-selective electrode is a voltage source with a high internal impedance, typically in the range of several hundreds MΩ. So potentiometric measurement of the potential developing at the ion-sensitive electrode requires a high impedance voltage measurement capability.

Healthy function of the sensor can be assumed if the impedance of the glass bulb is in a range of several hundred MΩ, for example in a range between 100 MΩ and 500 MΩ.

One of the most widely applied, although not a limiting, example for such a potentiometric sensor assembly is a potentiometric pH-sensor assembly. Ion sensitive electrodes that measure pH are well known in the prior art. Conventionally, pH sensors often consist of a measurement or pH electrode and reference electrode, each having a silver wire (Ag) with a silver chloride (AgCl) coating at its end. The pH electrode typically has an internal filled chloride buffer in aqueous solution having a selected pH (chloride buffer) that is often a pH of about 7 and a pH sensitive glass surrounding the internal silver wire and chloride buffer. The reference electrode typically has a container with an internal-filled reference solution of potassium chloride in aqueous solution (reference solution). The ion-sensitive glass typically has two hydrated gel layers, one layer on the inside surface and another on the outside surface. PH sensing is accomplished when a potential difference develops between the two hydrated gel layers. A hydrogen ion does not exist by itself in aqueous solution. It is associated with a water molecule to form a hydronium ion (H₃O⁺). The glass enclosed pH electrode develops a potential when hydronium ions get close enough to the glass bulb surface for hydrogen ions to jump and become associated with hydronium ions in an outer hydrated gel layer disposed on the glass bulb surface. This thin gel layer is essential for electrode response. The input to the pH measurement circuit in a pH sensor is the potential difference that develops between the external glass surface having potential Eg that is exposed to the sample liquid and the internal glass surface having potential Er that is wetted by the chloride buffer having the selected pH. The potential difference that develops follows the Nernst equation. Assuming the chloride buffer has a temperature of 25° C. and a pH of 7 then the potential difference (which is conventionally also the input to the ion-sensing, here pH measurement, circuit) is:

E_{g}−Eᵣ˜0.1984 (T+273.16)(7−pH).

The potential difference that develops is proportional to the deviation of the process pH from 7 pH at 25° C. If the pH of the process stream equals 7 then the potential difference measured will be zero.

Measurement of the impedance of the ion-sensitive glass bulb is an appropriate means to provide glass bulb diagnostics, such as “broken glass” and “out of solution”. It allows a smart ion-sensitive sensor, such as a smart pH sensor, to provide such glass diagnostics. This allows the user to be notified when there are cracks in the ion-sensitive glass, which would make the measurement invalid, or when there is no sample present.

In the prior art such glass bulb diagnostics requires a solution ground rod, either integrated into the sensor, or external to the sensor. A solution ground rod usually comprises a metallic pin or rod in direct contact with the sample to be measured. The metallic pin or rod is usually stainless steel or titanium giving good chemical resistance. This gives the electronics direct electrical contact to the solution. The electronics can then measure the impedance between the glass electrode and the solution earth. U.S. Pat. No. 6,894,502 B2 shows this exemplarily.

However, the addition of a solution earth electrode adds complexity to the electrode assembly.

### SUMMARY

In an embodiment, the present invention provides a method for monitoring a sensor function of a potentiometric sensor, the potentiometric sensor comprising: an ion-sensitive electrode including an ion-sensitive glass bulb; a reference electrode assembly including a reference electrode; and an ion-sensing circuit having a first terminal connected to the ion-sensitive electrode and a second terminal connected to the reference electrode, the circuit being configured to measure the potential difference that develops in the loop between the reference and the ion-sensitive electrode, the method comprising the steps of: a) injecting a pre-defined electric test current from the ion-sensing circuit into the loop comprising the reference and the ion-sensitive electrode; b) monitoring an additional potential difference that develops in the loop between the reference and the ion-sensitive electrode in reaction to the injection of the test current; and c) determining if the additional potential difference is within an expected range characterizing healthy function of the sensor.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic and exemplary potentiometric sensor assembly according to an embodiment of the invention,

FIG. 2 shows a schematic electric equivalent circuit of the potentiometric sensor assembly shown in FIG. 1.

### DETAILED DESCRIPTION

It is therefore the objective of the present invention to provide a potentiometric sensor assembly which allows glass-bulb diagnostics to be performed without the need for a solution ground rod. It is a further objective of the present invention to provide a method for monitoring the sensor function of a potentiometric sensor, particularly glass-bulb diagnostics, without the need for a solution ground rod.

The objective is achieved according to the invention by a method as described herein. The objective is further achieved by a potentiometric sensor assembly as described herein.

So according to the invention, the method for monitoring the sensor function of a potentiometric sensor comprises the steps of
a) pre-defining a range of the electric impedance of the glass bulb characterizing a healthy function of the sensor,
b) injecting a pre-defined electric test current from the ion-sensing circuit into the loop comprising the reference and the ion-sensitive electrode,
c) monitoring the additional potential difference (□V1) that develops in the loop between the reference and the ion-sensitive electrode in reaction to the injection of the test current,
d) calculating the electric impedance of the ion-sensitive glass bulb from the electric test current and the additional potential difference (□V1),
e) determining if the calculated impedance of the ion-sensitive glass bulb is within the pre-defined range of the electric impedance of the glass bulb characterizing a healthy function of the sensor.

In an advantageous embodiment, the method further comprises the step
f) issuing a “out of solution”—warning if the calculated impedance of the ion-sensitive glass bulb is higher than the highest value in the pre-defined range of values of the electric impedance of the glass bulb characterizing a healthy function of the sensor, and issuing a “broken glass” warning, if the calculated impedance of the ion-sensitive glass bulb is lower than the lowest value in the pre-defined range of values of the electric impedance of the glass bulb characterizing a healthy function of the sensor.

In a potentiometric sensor assembly according to the invention, the ion-sensing circuit is further designed to
a) inject a pre-defined electric test current from the ion-sensing circuit into the loop comprising the reference and the ion-sensitive electrode,
b) monitor the additional potential difference (ΔV1) that develops in the loop between the reference and the ion-sensitive electrode in reaction to the injection of the test current,
c) calculate the electric impedance of the ion-sensitive glass bulb from the electric test current and the additional potential difference (ΔV1),
e) determine if the calculated impedance of the ion-sensitive glass bulb is within the pre-defined range of values of the electric impedance of the glass bulb characterizing a healthy function of the sensor.

In an advantageous embodiment, the reference electrode assembly comprises a container containing a reference buffer in contact with a liquid junction extending to an outside surface of the container, and that the reference electrode is disposed in the container and in contact with the reference buffer.

In an advantageous embodiment, the ion-selective electrode further comprises a second container containing an ion-buffer, wherein at least a part of the second container is composed of the ion-sensitive glass bulb.

In an advantageous embodiment, the ion-sensitive electrode is a pH-sensitive electrode, the ion-buffer is a pH-buffer and the ion-sensitive glass bulb is made of pH-sensitive glass, the pH-sensitive electrode comprising a silver wire coated at least partly with silver chloride in contact with the pH-buffer.

In an advantageous embodiment, the ion-sensing circuit is further designed to preform one or more out of amplification, filtering, analog to digital conversion, signal transmission with respect to the potential difference that develops in the loop between the reference and the ion-sensitive electrode.

In an advantageous embodiment, the ion-sensing circuit is designed as a distributed electronic circuit, wherein at least a part of the functions of amplification, filtering, analog to digital conversion, signal transmission with respect to the potential difference that develops in the loop between the reference and the ion-sensitive electrode is executed in such a part of the ion-sensitive circuit that forms a separable or inseparable unit with the ion-sensitive electrode.

In an advantageous embodiment, the ion-sensitive circuit further comprises a micro-processor and a data storage device for storing at least an application program for the micro-processor and sensor configuration data and sensor measurement data.

In an advantageous embodiment, the ion-sensing circuit further comprises an interface for outputting a signal to a higher-order unit, particularly a transmitter, and/or for receiving a signal from the higher-order unit.

In an advantageous embodiment, the ion-sensing circuit is further designed to issue a “out of solution”—warning if the calculated impedance of the ion-sensitive glass bulb is higher than the highest value in the pre-defined range of values of the electric impedance of the glass bulb characterizing a healthy function of the sensor, and to issue a “broken glass” warning, if the calculated impedance of the ion-sensitive glass bulb is lower than the lowest value in the pre-defined range of values of the electric impedance of the glass bulb characterizing a healthy function of the sensor.

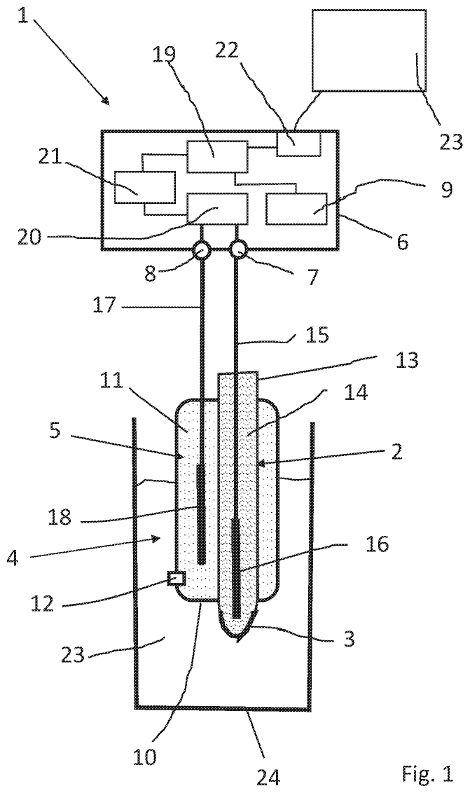

FIG. 1 shows a potentiometric sensor assembly 1. It has an ion-sensitive electrode 2, here a pH-electrode 2, which includes an ion-sensitive, here a pH-sensitive, glass bulb 3. It further has a reference electrode assembly 4, including a reference electrode 5. The ion-sensitive electrode 2 and the reference electrode 5 are electrically connected to an ion-sensing circuit 6. The ion-sensing circuit 6 has a first terminal 7 connected to the ion-sensitive electrode 2 and a second terminal 8 connected to the reference electrode 5.

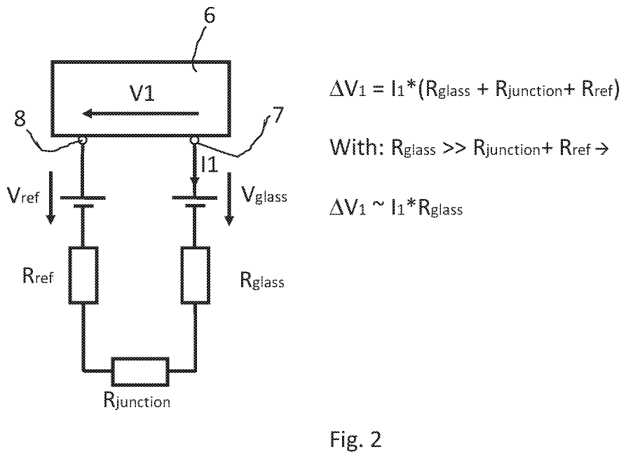

When immersed into an aqueous solution 23 to be analysed, in the exemplary scheme of FIG. 1 this aqueous solution 22 is contained in a container 24, a potential difference V1 will develop between the terminals 7 and 8, as is illustrated in the electrical equivalent circuit shown in FIG. 2. Vglass is the potential difference that develops across the ion-sensitive glass bulb 3 and which is a measure for the ion concentration in the aqueous solution 23. Vref is the potential that develops at the reference electrode 5 and which is more or less constant.

The ion-sensing circuit 6 is designed to measure the potential difference V1 that develops in the loop between the reference and the ion-sensitive electrode 2, 5, see FIG. 2.

The ion-sensing circuit 6 further has a digital storage unit 9 which is designed to save at least a range of values of the electric impedance of the glass bulb 3 characterizing a healthy function of the sensor 2.

The reference electrode assembly 4 comprises a container 10 containing a reference buffer 11 in contact with a liquid junction 12 extending to an outside surface of the container 10. The liquid junction is basically known to the skilled person, it can be for example a diaphragm. The reference electrode 5 is disposed in the container 10 and in contact with the reference buffer 11. The reference electrode 5 comprises a silver wire 17 coated at least partly with silver chloride 18 in contact with the reference-buffer 11

The ion-selective electrode 2 further comprises a second container 13 containing an ion-buffer 14, wherein the lower part of the second container 13 is composed of the ion-sensitive glass bulb 3.

Particularly, the ion-sensitive electrode 2 is a pH-sensitive electrode, the ion-buffer 14 is a pH-buffer and the ion-sensitive glass bulb 3 is made of pH-sensitive glass, the pH-sensitive electrode comprising a silver wire 15 coated at least partly with silver chloride 16 in contact with the pH-buffer 14.

The ion-sensing circuit 6 is further designed to preform one or more out of amplification, filtering, analog to digital conversion, signal transmission with respect to the potential difference that develops in the loop between the reference electrode 5 and the ion-sensitive electrode 2. In the electrical equivalent circuit shown in FIG. 2, the potential difference is marked as V1, and it is connected between the first terminal 7 and the second terminal 8 of the ion-sensing circuit 6.

To fulfil its functionality, the ion-sensitive circuit 6 further comprises a micro-processor 19 and a data storage device 9 for storing at least an application program for the micro-processor 19 and sensor configuration data and sensor measurement data. The ion-sensitive circuit further has an amplifier 20, which may have integrated filtering functionality, and analog-to-digital converter 21 for digitalization of the measured and amplified resp. filtered measurement values of the potential difference V1.

The ion-sensing circuit 6 further comprises an interface 22 for outputting a signal to a higher-order unit 23, particularly a transmitter, and/or for receiving a signal from the higher-order unit 23.

The potentiometric sensor assembly 1 allows for a glass-bulb diagnostics to be performed with the following steps.

A pre-defined electric test current I1 is injected from the first terminal 7 of the ion-sensing circuit 6 into the loop comprising the ion-sensitive electrode 2 and the reference electrode 5. The additional potential difference ΔV1 that develops in the loop between the reference and the ion-sensitive electrode in reaction to the injection of the test current I1 is monitored by the ion-sensing circuit 6. With reference to the electric equivalent circuit shown in FIG. 2, one can see that, when a current I1 is injected at the first terminal 7, the voltage V1 changes by

ΔV1=I1*(Rglass+Rref+Rjunction).

Rglass is the electric resistance or electric impedance of the ion-sensitive glass bulb 3. Rref is the electric resistance or electric impedance of the reference electrode 5. Rjunction is the electric resistance or electric impedance of the liquid junction 12, for example the diaphragm 12.

Rglass will be many orders of magnitude more than the sum of Rref+Rjunction. A typical value, exemplarily and not limiting, may be 300 MΩ for Rglass and 50 kΩ for the sum of Rref+Rjunction. So in a good approximation, one can say that

ΔV1=I1*Rglass.

One can even calculate the electric impedance Rglass of the ion-sensitive glass bulb 3 from the electric test current I1 and the additional potential difference ΔV1 as follows:

Rglass=ΔV1/I1

This approximation introduces very little error. With typical values of 300MΩ for Rglass and 50KΩ for Rreference, the approximation gives an error of 0.016% on the glass resistance Rglass, which is smaller than the measurement circuits intrinsic error within the ion-sensing circuit 6.

This allows the ion-sensing circuit 6 to provide broken glass and out of solution diagnostics, by determining if either the additional potential difference ΔV1 is within an expected range characterizing healthy function of the sensor, or if the calculated impedance Rglass of the ion-sensitive glass bulb 3 is within the pre-defined range of values of the electric impedance of the glass bulb characterizing a healthy function of the sensor.

In case of a broken glass, conducting liquid will be able to flow through cracks and short-circuit the high glass impedance, the calculated glass impedance Rglass will deteriorate, and so will the additional potential difference ΔV1.

On the other hand, in case the ion-sensitive electrode 2 is out of solution, is not immersed in a aqueous solution, the glass impedance Rglass will become very much higher than the several hundred MQ it has in normal operation, and the ion-sensing circuit 6 would notify this. In fact, if the ion-sensitive electrode 2 falls out of solution, the electric loop in the equivalent circuit formed by Vglass—Rglass—Rjunction—Rref—Vref gets interrupted. The additional voltage ΔV1 will grow out of range, and so will grow the calculated glass impedance Rglass, until the ion-sensing circuit 6 will notify open terminals 7, 8.

So the ion-sensing circuit is further designed to issue a “out of solution”—warning if the additional potential difference ΔV1 is higher than the highest value in an expected range characterizing healthy function of the sensor, and to issue a “broken glass” warning, if the additional potential difference (ΔV1) is lower than the lowest value in an expected range characterizing healthy function of the sensor.

If the electric impedance of the glass bulb is calculated, the ion-sensing circuit 6 is further designed to issue a “out of solution”—warning if the calculated impedance of the ion-sensitive glass bulb is higher than the highest value in the pre-defined range of values of the electric impedance of the glass bulb characterizing a healthy function of the sensor, and to issue a “broken glass” warning, if the calculated impedance of the ion-sensitive glass bulb is lower than the lowest value in the pre-defined range of values of the electric impedance of the glass bulb characterizing a healthy function of the sensor.

The ion-sensing circuit 6 may further be designed as a distributed electronic circuit, wherein at least a part of the functions of amplification 20, filtering, analog to digital conversion 21, signal transmission 22 with respect to the potential difference that develops in the loop between the reference and the ion-sensitive electrode is executed in such a part of the ion-sensitive circuit that forms a separable or inseparable unit with the ion-sensitive electrode 2.

The electric test current I1 may be a DC or an AC current. AC currents have an advantage in that the risk of building up of additional electrochemical diffusion potentials at the respective electrodes which may become an additional source of error is minimized.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of reference signs

| | |
|---|---|
| 1 | Potentiometric sensor assembly |
| 2 | Ion-sensitive electrode, pH-electrode |
| 3 | Ion-sensitive glass bulb |
| 4 | Reference electrode assembly |
| 5 | Reference electrode |
| 6 | Ion-sensing circuit |
| 7 | First terminal |
| 8 | Second terminal |
| 9 | Digital storage unit |
| 10 | Container |
| 11 | Reference buffer |
| 12 | Liquid junction |
| 13 | Second container |
| 14 | Ion buffer, pH buffer |
| 15 | Silver wire |
| 16 | Silver chloride |
| 17 | Silver wire |
| 18 | Silver chloride |
| 19 | Micro processor |
| 20 | Amplifier |
| 21 | A/D converter |
| 22 | Interface |
| 23 | Aqueous solution |
| 24 | container |
| ΔV1 | additional potential difference |
| I1 | Test current |

What is claimed is:

1. A method for monitoring a sensor function of a potentiometric sensor, the potentiometric sensor comprising:
an ion-sensitive electrode including an ion-sensitive glass bulb;
a reference electrode assembly including a reference electrode; and
an ion-sensing circuit having a first terminal connected to the ion-sensitive electrode and a second terminal connected to the reference electrode, the circuit being configured to measure the potential difference that develops in the loop between the reference and the ion-sensitive electrode,
the method comprising the steps of:
a) injecting a pre-defined electric test current from the ion-sensing circuit into the loop comprising the reference and the ion-sensitive electrode;
b) monitoring an additional potential difference that develops in the loop between the reference and the ion-sensitive electrode in reaction to the injection of the test current; and
c) determining if the additional potential difference is within an expected range characterizing healthy function of the sensor.

2. The method according to claim 1, further comprising the steps of:
d) pre-defining a range of the electric impedance (Rglass) of the glass bulb characterizing a healthy function of the sensor;
e) calculating the electric impedance (Rglass) of the ion-sensitive glass bulb from the electric test current and the additional potential difference; and
f) determining if the calculated impedance (Rglass) of the ion-sensitive glass bulb is within the a pre-defined range of the electric impedance of the glass bulb characterizing a healthy function of the sensor.

3. The method according to claim 1, further comprising the step of:
g) issuing an “out of solution” warning if the additional potential difference is larger than an expected range characterizing healthy function of the sensor, and issuing a “broken glass” warning if the additional potential difference is lower than an expected range characterizing healthy function of the sensor.

4. The method according to claim 2, further comprising the step of:
h) issuing a “out of solution” warning if the calculated impedance (Rglass) of the ion-sensitive glass bulb is higher than a highest value in the pre-defined range of values of the electric impedance of the glass bulb characterizing a healthy function of the sensor, and issuing a “broken glass” warning if the calculated impedance (Rglass) of the ion-sensitive glass bulb is lower than a lowest value in the pre-defined range of values of the electric impedance of the glass bulb characterizing a healthy function of the sensor.

5. A potentiometric sensor assembly for executing the method of claim 1, comprising:
the ion-sensitive electrode including an ion-sensitive glass bulb;
the reference electrode assembly including a reference electrode;
the ion-sensing circuit having the first terminal connected to the ion-sensitive electrode and the second terminal connected to the reference electrode, the circuit being configured to measure the potential difference that develops in the loop between the reference and the ion-sensitive electrode; and
a digital storage unit configured to save at least an expected range of the additional potential difference characterizing healthy function of the sensor and/or a range of values of the electric impedance (Rglass) of the glass bulb characterizing a healthy function of the sensor,
wherein the ion-sensing circuit is further configured to:
a) inject the pre-defined electric test current from the ion-sensing circuit into the loop comprising the reference and the ion-sensitive electrode;
b) monitor the additional potential difference that develops in the loop between the reference and the ion-sensitive electrode in reaction to the injection of the test current; and
c) determine if the additional potential difference is within the expected range characterizing healthy function of the sensor.

6. A potentiometric sensor assembly for executing the method of claim 2, wherein the ion-sensing circuit is further configured to:
d) calculate the electric impedance (Rglass) of the ion-sensitive glass bulb from the electric test current and the additional potential difference; and
e) determine if the calculated impedance (Rglass) of the ion-sensitive glass bulb is within the pre-defined range of values of the electric impedance (Rglass) of the glass bulb characterizing a healthy function of the sensor.

7. The potentiometric sensor assembly according to claim 5, wherein the reference electrode assembly comprises a container containing a reference buffer in contact with a liquid junction extending to an outside surface of the container, and
wherein the reference electrode is disposed in the container and in contact with the reference buffer.

8. The potentiometric sensor assembly according to claim 7, wherein the ion-selective electrode further comprises a second container containing an ion-buffer, and
wherein at least a part of the second container comprises the ion-sensitive glass bulb.

9. The potentiometric sensor assembly according to claim 8, wherein the ion-sensitive electrode comprises a pH-sensitive electrode, the ion-buffer comprises a pH-buffer, and the ion-sensitive glass bulb comprises pH-sensitive glass, and
wherein the pH-sensitive electrode comprises a silver wire coated at least partly with silver chloride in contact with the pH-buffer.

10. The potentiometric sensor assembly according to claim 5, wherein the ion-sensing circuit is further configured to preform one or more of amplification, filtering, analog to digital conversion, and signal transmission with respect to the potential difference that develops in the loop between the reference and the ion-sensitive electrode.

11. The potentiometric sensor assembly according to claim 10, wherein the ion-sensing circuit comprises a distributed electronic circuit,
wherein at least a part of the amplification, filtering, analog to digital conversion, and signal transmission with respect to the potential difference that develops in the loop between the reference and the ion-sensitive electrode is executed in a part of the ion-sensitive circuit that forms a separable or inseparable unit with the ion-sensitive electrode.

12. The potentiometric sensor assembly according to claim 10, wherein the ion-sensitive circuit further comprises a micro-processor and a data storage device configured to store at least an application program for the micro-processor and sensor configuration data and sensor measurement data.

13. The potentiometric sensor assembly according to claim 12, wherein the ion-sensing circuit further comprises an interface configured to output a signal to a higher-order unit comprising a transmitter, and/or to receive a signal from the higher-order unit.

14. The potentiometric sensor assembly according to claim 6, wherein the ion-sensing circuit is further configured to issue a “out of solution” warning if the calculated impedance (Rglass) of the ion-sensitive glass bulb is higher than a highest value in the pre-defined range of values of the electric impedance of the glass bulb characterizing a healthy function of the sensor, and to issue a “broken glass” warning if the calculated impedance (Rglass) of the ion-sensitive glass bulb is lower than a lowest value in the pre-defined range of values of the electric impedance of the glass bulb characterizing a healthy function of the sensor.

15. The potentiometric sensor assembly according to claim 5, wherein the ion-sensing circuit is further configured to issue a “out of solution” warning if the additional potential difference is higher than a highest value in an expected range characterizing healthy function of the sensor, and to issue a “broken glass” warning if the additional potential difference is lower than a lowest value in an expected range characterizing healthy function of the sensor.
